(19) United States
(12) Patent Application Publication
(10) Pub. No.: US 2019/0225115 A1
(43) Pub. Date: Jul. 25, 2019

(54) MODULAR VEHICLE FOR PEDESTRIAN ENVIRONMENT

(71) Applicant: WATTMAN TRAINS & TRAMS INC., Grandy (CA)

(72) Inventors: Renaud LAROUCHE, Sherbrooke (CA); Alain LEBLANC, Ayer's Cliff (CA); Rod FORTIN, Granby (CA); David GALLEY, Acton Vale (CA); Bertrand LEGAULT, Granby (CA); Michel TROTTIER, Saint-Lambert (CA); Brigitte BOMBARDIER, Valcourt (CA)

(21) Appl. No.: 16/337,911

(22) PCT Filed: Sep. 29, 2017
(86) PCT No.: PCT/CA2017/051160

§ 371 Date: Mar. 28, 2019

Related U.S. Application Data
(60) Provisional application No. 62/401,549, filed on Sep. 29, 2016.

(51) Int. Cl. B60N 2/01; B60K 1/04; B60K 26/02; B62D 51/02; B62D 47/00

(52) U.S. Cl. CPC B60N 2/01; B60K 1/04; B60K 26/02; B62D 51/02; B60Y 2400/83; B60K 2026/025; B60K 2026/029; B60Y 2200/143; B60Y 2200/86; B62D 47/00

(57) ABSTRACT

A modular vehicle for transporting an individual, the vehicle comprising a main frame comprising a rear end and a front end opposite to the rear end, the main frame defining a longitudinal axis. The modular vehicle comprises at least two seats mounted side-by-side in a single row substantially perpendicular to the longitudinal axis, each of the at least two seats adapted for seating an individual, each of the two seats comprising a seat surface; and a backrest facing substantially toward the front end. The modular vehicle further comprises a driving area at the rear end of the main frame for driving the vehicle.

### CROSS-REFERENCE TO RELATED APPLICATION

This application claims priority from U.S. patent provisional application 62/401,549 filed Sep. 29, 2016, the specification of which is hereby incorporated herein by reference in its entirety.

### BACKGROUND

### (a) Field

The subject matter disclosed generally relates to vehicles for pedestrian environments. More particularly, the subject matter disclosed relates to vehicles for transporting individuals/passengers in pedestrian environments such as airports, shopping centres, amusement parks, hotels, tourist areas, hospitals and the like.

### (b) Related Prior Art

In many pedestrian environments, such as, without limitation, airports, shopping centres, amusement parks, hotels, tourist areas, hospitals, and the like, typical golf karts are often used to transport individuals (i.e., children, elderly people, travellers during their flight connections, etc.). Even if golf karts are very useful on golf playgrounds, they are often not the better option for other pedestrian environments.

For example, in airports, when travellers are late for a flight, airplane companies often transport them from one gate to another. Conventional golf karts are often used for this purpose even if it does not provide a safe environment for the airplane company's customers and enough space for travellers with their luggage. Furthermore, as the driver is located in front of the passengers transported by his conventional golf kart, he has no clue about what is going on in the golf kart (i.e., behind him) and behind the golf kart itself. Using golf karts to transport passengers in an airport can therefore be an unsafe practice.

On the other hand, a conventional golf kart may sometimes be hard to drive in pedestrian environments, as it needs to be driven as a conventional car. Objects or children can be located in front or in the back of the golf kart, and injuries can occur while the driver travels within a pedestrian environment.

Furthermore, conventional golf karts often provide room to transport a small number of individuals, while there is often a need to transport larger groups of individuals in the pedestrian environment.

Moreover, it is often not convenient for travellers to get in and out a conventional gold kart with their luggage due to actual configurations of golf karts.

There is therefore a need for vehicles for transporting individuals in pedestrian environments that are safe, easily accessible by individuals and easily manoeuvrable by drivers.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### SUMMARY

According to an embodiment, there is disclosed a vehicle for transporting passengers, the vehicle comprising: a main frame comprising a rear end and a front end opposite the rear end, the main frame defining a longitudinal axis; a passenger area comprising more than one row of at least two seats mounted side-by-side, the more than one row being substantially perpendicular to the longitudinal axis whereby the at least two seats in each of the more than one row face the front end, each of the at least two seats adapted for seating a single passenger; and a driving area behind the passenger area at the rear end of the main frame.

According to an aspect, each of the at least two seats comprises: a seat surface; and a backrest facing substantially toward the front end.

According to an aspect, the driving area further comprises a driving console comprising a handheld controller operable by to operate the vehicle, wherein the handheld controller is operable by a driver in a standing or semi-standing position.

According to an aspect, the handheld controller is able to be tilted about a first plane and a second plane, wherein tilting the handheld controller about the first plane controls forward and backward displacement of the vehicle and tilting the handheld controller about the second plane controls direction of the vehicle.

According to an aspect, the handheld controller further controls at least one of speed of the vehicle and braking of the vehicle.

According to an aspect, the driving area comprise a side wall, wherein the driving console is mounted to the side wall thereby enabling one-hand operation of the handheld controller, and hence the vehicle, by the driver.

According to an aspect, the driving area comprises a side wall, a front wall and a back wall thereby closing off the driving area on three sides.

According to an aspect, the passenger area comprises a passenger area floor and the driving area comprises a driving area floor, wherein the driving area floor is higher than the passenger area floor.

According to an aspect, the vehicle further comprises two axles which are mounted to the main frame, wherein one of the two axles is for steering the vehicle, and wherein the driving area is located rearward of the two axles.

According to an aspect, the vehicle further comprises a left side and right side, wherein the left side and the right side are at least partially opened allowing individuals to board on the vehicle and to leave the vehicle from the left side and the right side of the vehicle.

According to an embodiment, there is disclosed a vehicle for transporting passengers, the vehicle comprising: a main frame comprising a front end and a rear end opposite to the front end, the main frame defining a longitudinal axis; a passenger area comprising a row substantially perpendicular to the longitudinal axis, the row having at least two seats mounted side-by-side with each seat being for seating a single passenger and wherein the at least two seats face the front end; and a driving area located behind the passenger area.

According to an aspect, the passenger area further comprises another row also comprising at least two seats which face the front end.

According to an aspect, each of the at least two seats comprises: a seat surface; and a backrest facing substantially toward the front end.

According to an aspect, the driving area further comprises a driving console comprising a handheld controller operable by a driver to operate the vehicle, wherein the handheld controller is operable by the driver in a standing or semi-standing position.

According to an aspect, the handheld controller is able to be tilted about a first plane and a second plane, wherein tilting the handheld controller about the first plane controls forward and backward displacement of the vehicle and tilting the handheld controller about the second plane controls direction of the vehicle.

According to an aspect, the handheld controller further controls at least one of speed of the vehicle and braking of the vehicle.

According to an aspect, the driving area comprise a side wall, wherein the driving console is mounted to the side wall thereby enabling one-hand operation of the handheld controller, and hence the vehicle, by the driver.

According to an aspect, the passenger area comprises a passenger area floor and the driving area comprises a driving area floor, wherein the driving area floor is higher than the passenger area floor.

According to an aspect, the vehicle further comprises two axles which are mounted to the main frame, wherein one of the two axles is for steering the vehicle, and wherein the driving area is located rearward of the two axles.

According to an aspect, the vehicle further comprises a left side and right side, wherein the left side and the right side are at least partially opened allowing individuals to board on the vehicle and to leave the vehicle from the left side and the right side of the vehicle.

### BRIEF DESCRIPTION OF THE DRAWINGS

Further features and advantages of the present disclosure will become apparent from the following detailed description, taken in combination with the appended drawings, in which:

FIG. 1 is an elevated perspective view of a modular vehicle for pedestrian environment in accordance with an embodiment;

FIG. 2 is a rear perspective view of the vehicle of FIG. 1;

FIG. 3 is a front perspective view of the vehicle of FIG. 1;

FIG. 4 is a top perspective view of the vehicle of FIG. 1;

FIG. 5 is a side perspective view of the vehicle of FIG. 1;

FIG. 6 is an opposite side perspective view of the vehicle of FIG. 1;

FIGS. 7 and 8 are frontmost elevation views of one side and of the opposite side of the vehicle of FIG. 1;

FIGS. 9 and 10 are rearmost elevation views of one side and of the opposite side of the vehicle of FIG. 1;

FIG. 11 is a frontmost elevated view of a modular vehicle for pedestrian environment according to an embodiment;

FIG. 12 is a back elevated view of the vehicle of FIG. 11; and

FIG. 13 is a schematic of the electric components and electric connections of a modular vehicle for pedestrian environment according to an embodiment.

It will be noted that throughout the appended drawings, like features are identified by like reference numerals.

### DETAILED DESCRIPTION

In embodiments, there are disclosed modular vehicles for pedestrian environment for transporting individuals/passengers in pedestrian environments such as, without limitation, airports, shopping centres, amusement parks, hotels, tourist areas, hospitals, and the like.

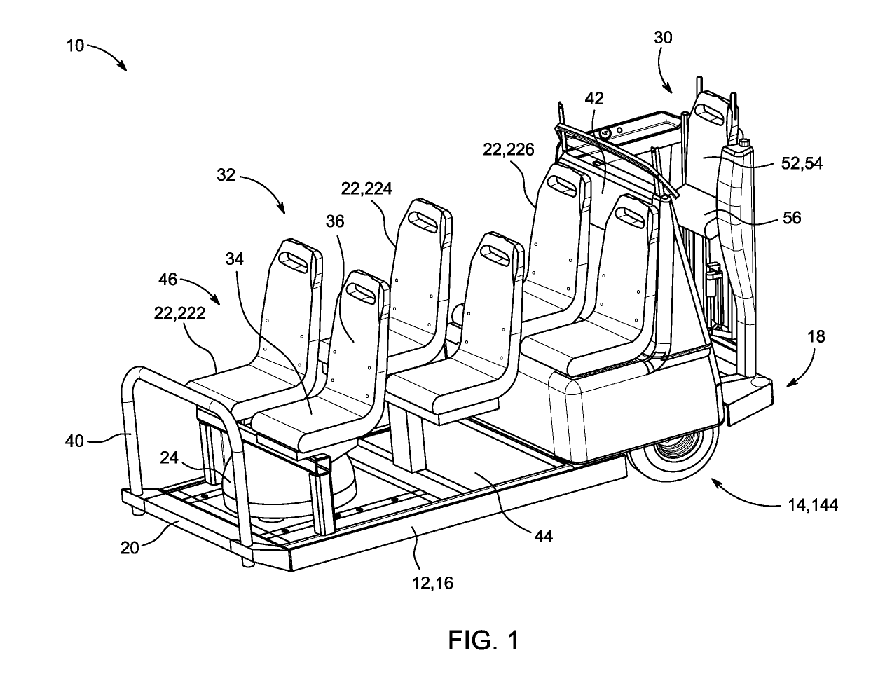

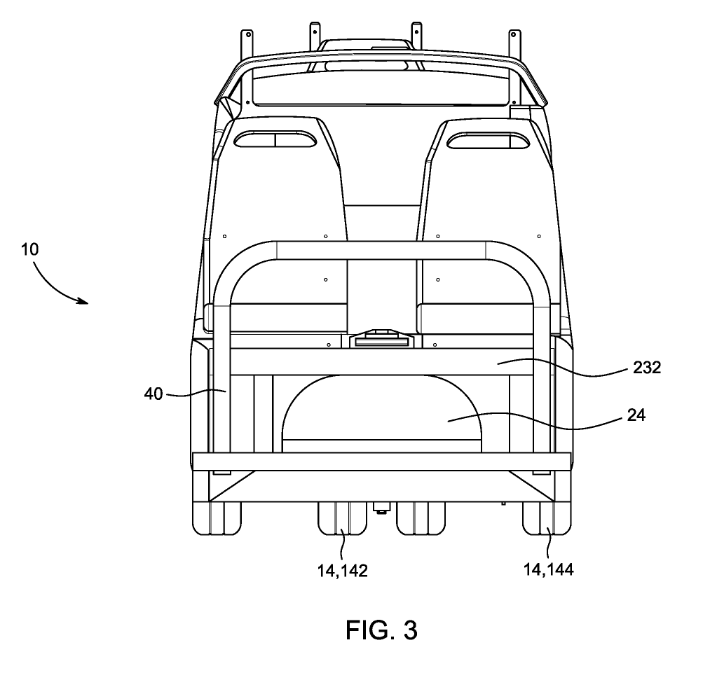

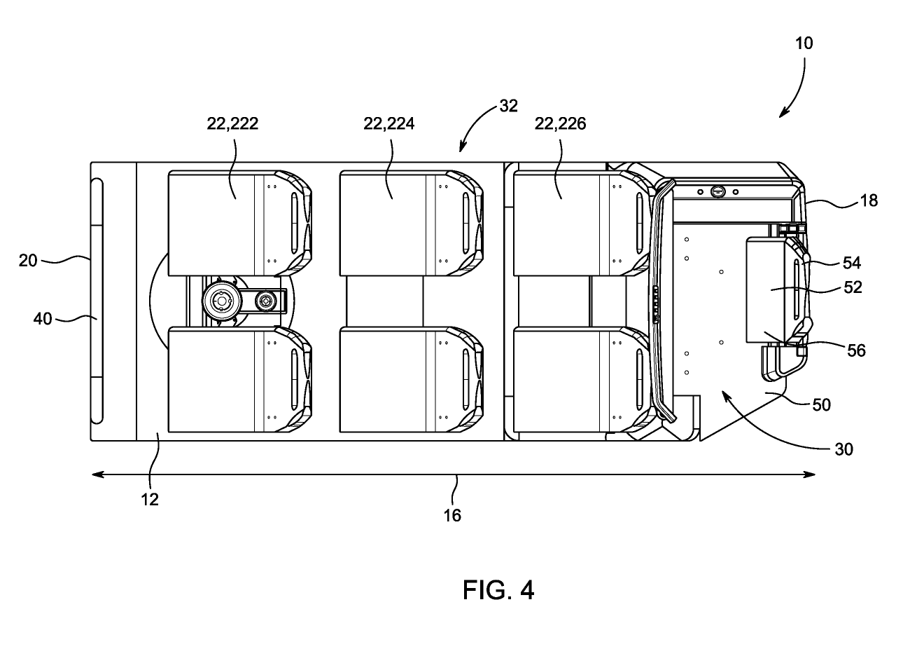

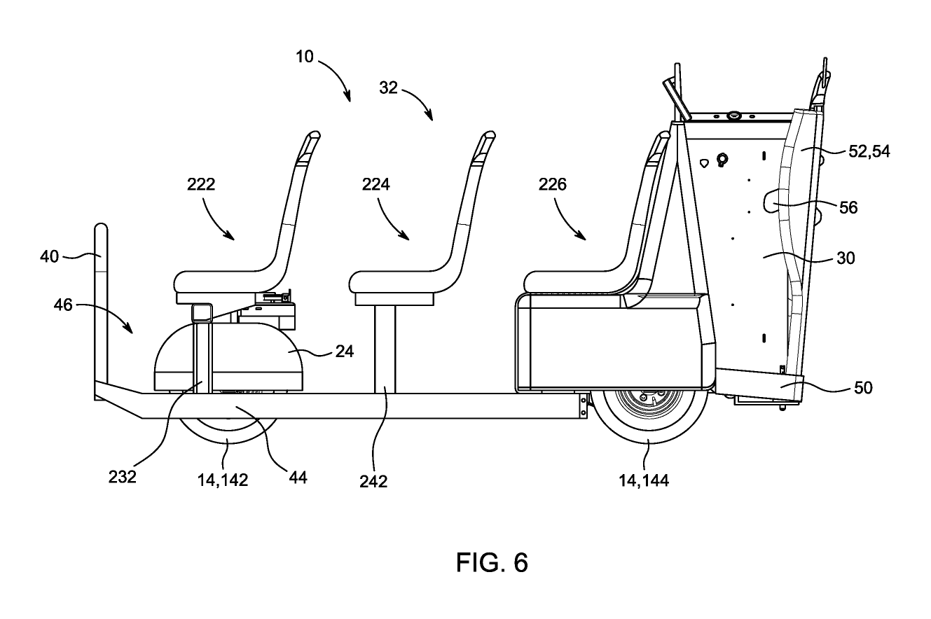

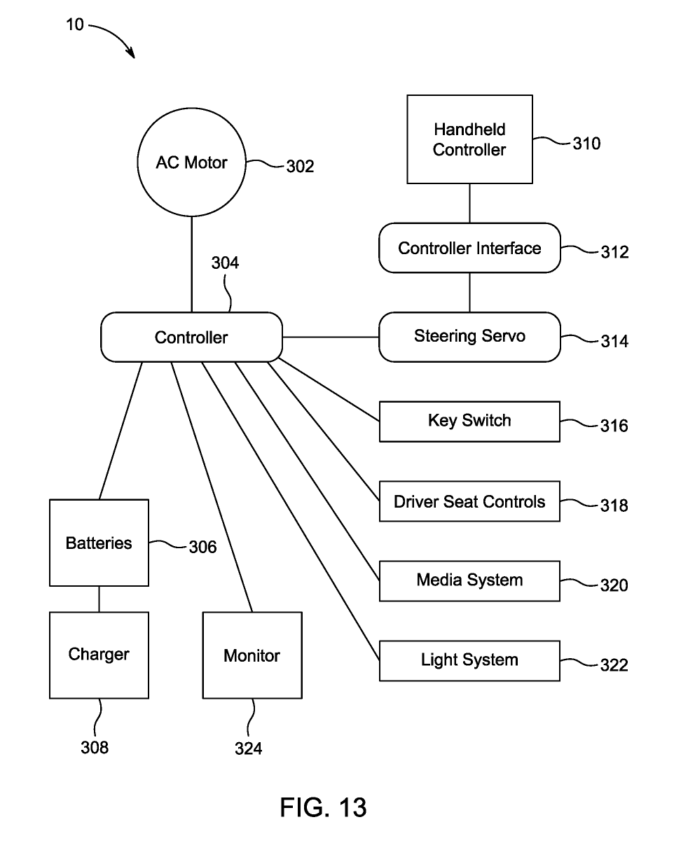

Referring now to the drawings, and more particularly to FIGS. 1-6, there is shown a modular vehicle 10 for transporting one or more passenger(s) (not shown) in pedestrian environments in accordance with an embodiment. The modular vehicle 10 comprises a main frame 12. The main frame 12 is mounted on two set of wheels 14, namely a set of front wheels 142 and a set of rear wheels 144, each mounted to its own axle. The main frame 12 defines a longitudinal axis 16 between the front end 20 of the main frame 12 and the rear end 18 of the main frame 12. The modular vehicle 10 further comprises an electric motor 302 (see FIG. 13) which is mounted on the main frame 12, and driving components (see FIG. 13) operatively connected to the motor via a controller 304 (see FIG. 13) for operating, namely steering and propelling, the main frame 12.

The modular vehicle 10 further comprises a passenger area 46 and a driving area 30. The modular vehicle 10 comprises, in the passenger area 46, a seat assembly 32 comprising a plurality of seats 22 mounted in rows 222, 224, 226, with each one of the rows 222, 224, 226 being individually mounted on the main frame 12. As shown in FIGS. 1-6, the seat assembly 32 comprises six seats 22. Each one of the rows 222, 224, 226 comprises two seats 22. Each one of the rows 222, 224, 226 is configured substantially perpendicular to the longitudinal axis 16 defined by the main frame 12.

It is to be noted that the seat assembly 32, according to alternative embodiments, comprise a lower number of rows (e.g. two), and a higher number of rows (e.g. three and four), each adapted for a number of seats 22 with each seat 22 able to receive one or more passengers. It is to be noted that the number of seats 22 per row vary according to embodiments. According to embodiments, one or more rows comprise either a single seat 22 or a larger number of seats 22 (e.g. three) depending on the specific body shape of the passengers who are intended to use these seats 22. Further, in some embodiments the number of seats 22 will vary between rows.

As shown in FIGS. 1-6, each seat 22 is intended for a single passenger, each defining a space for the passenger to sit (space for resting/supporting at least a passenger's legs, buttocks and back) and to place pieces of luggage. Each seat 22 comprises a seat surface 34, a backrest 36 and (optionally, and not shown on FIGS. 1-6) one or more seat arms. The seat surface 34 and the backrest 36 are according to the shown embodiment a single-piece component. It is to be noted that, according to alternative embodiments, the seats 22 are provided with alternative configurations and shapes, such as to allow a plurality of passengers to be easily and safely transported within the modular vehicle 10 for pedestrian environments. An example of an alternative configuration is a two-piece seat 22 with the seat surface 34 and the backrest 36 being independent from each other.

According to embodiments, the width and the depth of the seat surface 34 as the width and height of the backrest 36 vary. According to a shown embodiment, all seats 22 have the same width, depth and height. According to another embodiment (not shown), seats 22 have different width, depth and/or height for passengers of different body shapes. According to an embodiment (not shown), the height of the backrest 36 varies with the locations of the seats 22, the height of the seats 22 increasing as the location of the seats 22 being farther from the front end 20 of the modular vehicle 10.

The modular vehicle 10 comprises a driving area 30 closer to the rear end 18, and more specifically according to the shown embodiment, substantially at the rear end 18 of the main frame 12. A driver (not shown) operates the main frame 12 from the driving area 30. From this position, the driver sees all passengers directly thereby providing better security, safety and control of the passengers.

As shown in FIGS. 1-6, the passenger area 46 comprises a front safety rail 40 at or near the front end 20, a rear passenger area wall 42 near the rear end 18 and a passenger area floor member 44 which extends between the front safety rail 40 and the rear passenger area wall 42. The front safety rail 40, according to an embodiment, is embodied as a bent bar having a U-shape that is mounted to the main frame 12 at its two extremities. According to alternative embodiments, the front safety rail 40 is embodied as a front wall or a netted panel mounted to the main frame 12. The front safety rail 40 and its alternatives are intended to prevent passenger legs to extend over the front end 20 of the modular vehicle 10.

The main frame 12, according to an embodiment, comprises anti-slip components (not shown) on the passenger area floor member 44. The anti-slip components are aligned with and in front of each seat 22. The anti-slip components, according to an embodiment, extend towards the sides of the main frame 12 such as to provide an anti-slip surface for passengers to step on when boarding the modular vehicle 10. According to an embodiment, the whole passenger area floor member 44 is covered with anti-slip components.

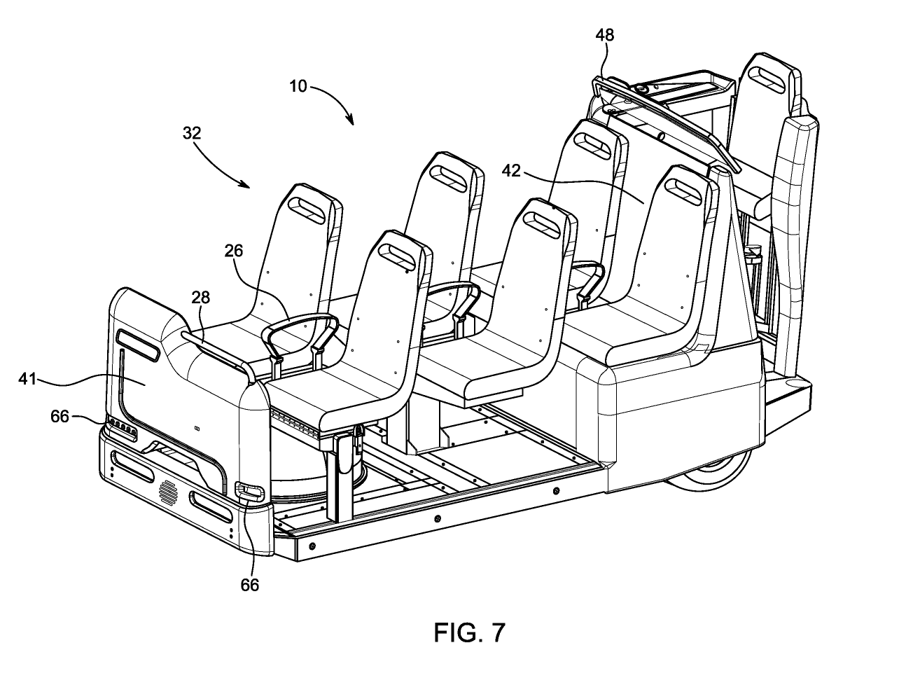

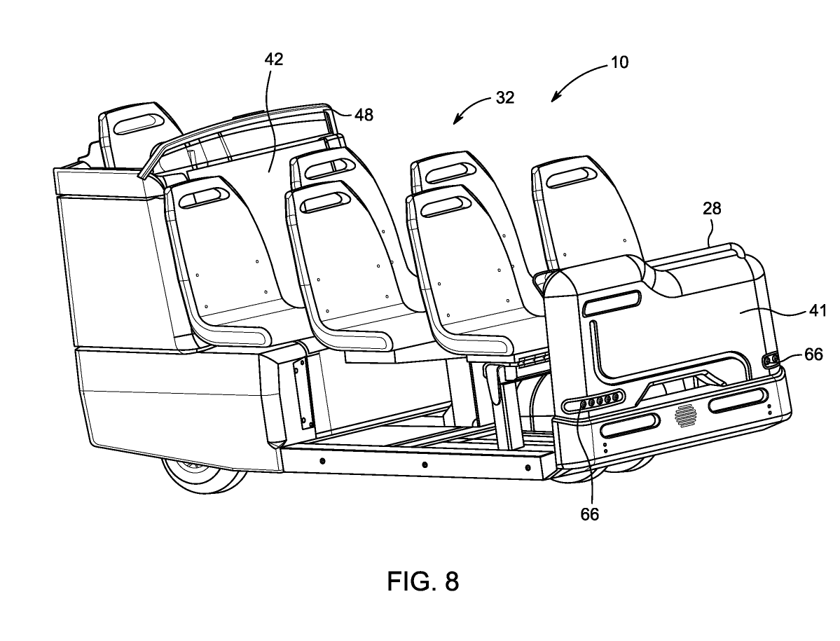

According to an embodiment, the seat assembly 32 further comprises one or more handle elements (i.e., central hand rails 26, FIG. 7) extending from the horizontal surface located between two seats 22 of the same row. According to an embodiment, the handle elements are embodied as side hand rails located on exterior sides of the seat assembly 32 instead of or additionally to the central hand rails 26. The side hand rails act as aids for passengers boarding the modular vehicle 10 and as a security feature to keep passenger for falling off the modular vehicle 10 once they have boarded the modular vehicle 10. Further, the side hand rails provide structure for securing additional components such as seatbelt drums. According to an embodiment, the seat assembly 32 further comprises additional handle elements such as a front handle 28 (see FIGS. 7 and 8), wherein the front handle 28 is part of the front safety rail 40 or extending from the exterior edge and/or top edge of the front wall 41, and/or a back rail 48 extending from the rear passenger area wall 42 for safety and convenience purposes. According to embodiments, alternative or additional railings are mounted to the modular vehicle 10 for passengers to handle during boarding, during course and/or when stepping out of the modular vehicle 10.

Still referring to FIGS. 1-6, the modular vehicle 10 features a front row 222 of seats 22 mounted on the main frame 12 above the front wheels 142. The front row 222 of seats 22 is located above the front wheels 142, with a shield 24 isolating the passenger area 46 from the front wheels 142. The front row 222 is mounted on a front row mount 232 having an inverted U-shape comprising two vertical members 234 mounted on the main frame 12 and a horizontal member 236 mounted at one extremity to one of the two vertical members 234 and at the other extremity to the other one of the two vertical members 234. The front row mount 232 extends above the shield 24 and provides the necessary elevation for the seats 22 of the front row 222 to be mounted on the main frame 12 through the front row mount 232. The central row 224 is mounted on a central row mount 242 having a T-shaped shape comprising a vertical member 244 mounted on the main frame 12 according to a first extremity, and a horizontal member 246 mounted through its centre on the second extremity of the vertical member 244. The seats 22 of the central row 224 are mounted to the horizontal member 246. Accordingly, free space under the seats 22 of the central row 224 is available for passengers to place, for instance, pieces of baggage.

It is to be noted that the passenger area 46 is limited at its front by the front safety rail 40 and at its rear by the rear passenger area wall 42. The passenger area 46 is not limited by a panel, rail or any other component on any of its sides, allowing passengers to board from both open sides.

According to alternative embodiments, access to the modular vehicle 10 by its sides is partially restricted by side walls (not shown) covering portions of the sides near the seats 22. According to an embodiment, hinged doors (not shown) are mounted to the side walls to temporarily close the sides when the modular vehicle 10 is moving.

It has to be noted that the front wheels 142 are mounted on the main frame 12 in such a manner that the front wheels 142 extends above a plane defined substantially by the passenger area floor member 44, allowing the passenger area floor member 44 to be relatively low with respect to the ground. The low position eases the boarding of the passengers stepping onto the passenger area floor member 44 as their exit from the modular vehicle 10, particularly for passengers having walking difficulties. Since the front wheels 142 extend above the general level of the passenger area floor member 44, a protection member such as the shield 24 is necessary to isolate the front wheels 142 from the passenger area 46 and thereby ensuring security of the passengers.

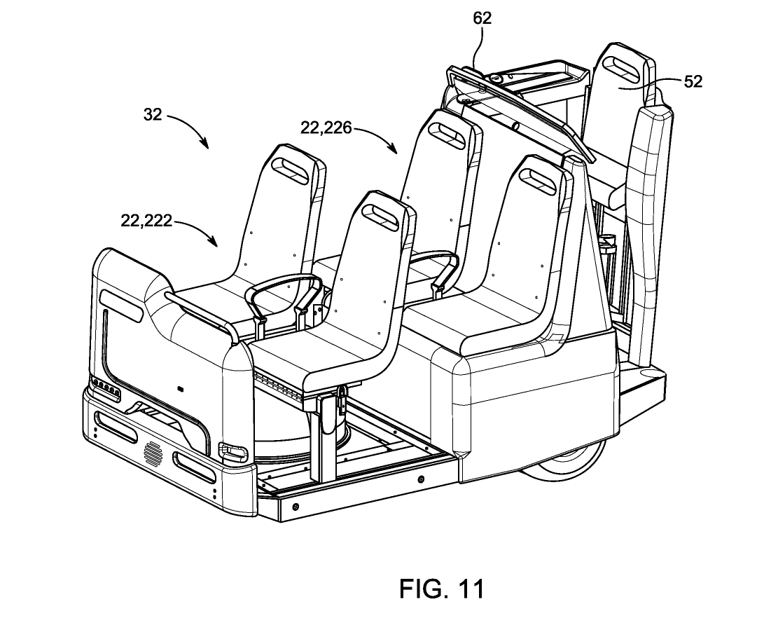

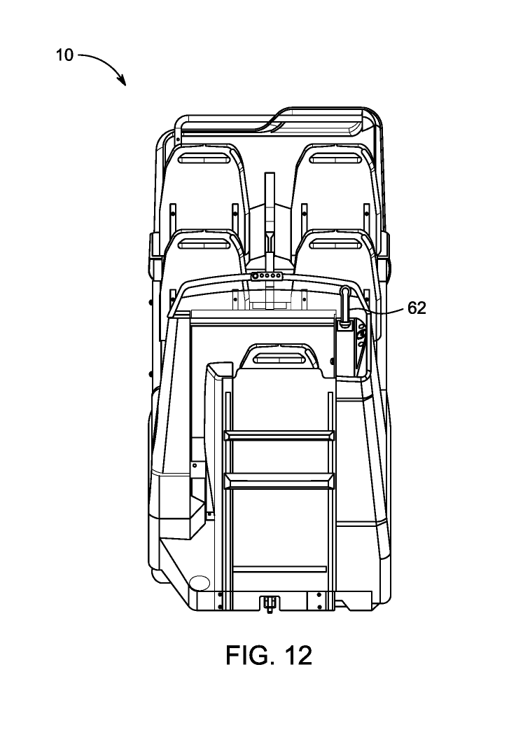

It is to be noted that the modular vehicle 10, according to an embodiment shown on FIGS. 1 to 6, comprises a single central row 224 of seats 22. According to an embodiment shown on FIGS. 11 and 12, the modular vehicle 10 comprises no central row 224, with the length of the main frame 12, and accordingly the size of the passenger area 46 shortened accordingly. The outcome is a lighter modular vehicle 10 while maintaining similar leg space for the passengers in the passenger area 46. According to another embodiment (not shown), the length of the main frame 12 and the size of the passenger area 46 are kept substantially the same thereby providing more leg space and baggage space to passengers. According to the latter embodiment, a dedicated baggage space (not shown) is defined in one embodiment at the front, in one embodiment at the center and in one embodiment at the rear portion of the passenger area 46. According to alternative embodiments, the modular vehicle 10 feature two or three central rows 224 of seats 22 to welcome more passengers, with the size of the passenger area 46 and thus the length of the central portion of the main frame 12 being increased accordingly.

According to embodiments (not shown), baggage areas comprises panels, anchoring components and/or nets to define partially closed baggage compartments or fully-closed compartments accessible via a door or a netted elastic curtain for example. Such baggage compartments ensure safe storage of the baggage, preventing slipping of baggage within or out of the baggage compartment.

According to an embodiment, each seat 22 of the seat assembly 32 further comprises seatbelts (i.e., such as full lap style seatbelts, or three anchoring-point seatbelts, both types not shown) for allowing passengers to be safely attached in the modular vehicle 10. Presence and type of seatbelts may depend on regulations with respect to the location where the modular vehicle 10 is operated.

According to an embodiment, the main frame 12 is at least partially made of metal or metal alloy, such as steel. According to an embodiment, the main frame 12 is at least partially made of another material such as, without limitation, a polymeric material, a composite material, and the like, as a combination of the materials thereof. According to an embodiment, the main frame 12 is made of a material that fulfills strength parameters and resistant parameters for the modular vehicle 10 to be able to carry its own weight and the weight of the passengers to be transported by the modular vehicle 10. According to an embodiment, the material is selected based on cost and weight considerations.

According to an embodiment, the seats 22 are made of a fibreglass material, of an ultra-violet (UV) resistant material, or of another suitable material that provides the required strength to resist to the weight of the passengers. According to an embodiment, the seats 22 are made of a material that is wear resistant, and that can easily be washed. According to an embodiment, alternative parameters are used to select the material(s) and/or design parameters involved in the design of the seats 22.

According to an embodiment, the fibreglass material further comprises an anti-microbial composition for allowing quick cleaning and maintenance.

Referring to the operation of the modular vehicle 10 by the driver, the modular vehicle 10 as described above comprises a driving area 30 providing a rear operational driver position. The passengers are seated in front of the driver. The driver is typically in a semi-standing or a standing position in the driving area 30. The modular vehicle 10, according to embodiments, provides at least a four to one (4/1) passenger/driver ratio based a two side-by-side passenger seats or seat positions per row. According to alternative embodiment, a higher ratio is provided when an increased number of rows and/or an increase of the number of passengers per row is used, thus optimizing operating costs.

As better shown on FIGS. 1, 4 and 6, the driving area 30 comprises a driving area floor member 50 and an adjustable driver seat 52 for the driver to be in a selected one of a semi-standing position (or perching position) or a standing position. For each of these positions, the adjustable driver seat 52 allows the driver to adjust the height of the adjustable driver seat 52 in a comfortable ergonomic position. The adjustable driver seat 52 comprises a driver backrest 54 and a driver seat surface 56. It is to be noted that the driver seat surface 56, according to embodiments, can be provided with any suitable shape and/or configuration such as to allow the driver to adopt any one of the semi-standing position, and the standing position. As stated, the driver seat surface 56 is adjustable between a plurality of seat positions to adapt to the height of the driver.

According to an embodiment, the adjustable driver seat 52 comprises a plurality of rods 94 disposed perpendicularly to internal opposite longitudinal rails 92 of the driver backrest 54. The driver can slide the driver seat surface 56 upward or downward along the internal opposite longitudinal rails 92 and lock driver seat surface 56 in a seat locked position with one of the plurality of rods 94.

According to an embodiment, the driver backrest 54 and/or the driver seat surface 56 are adjustable vertically and/or horizontally such as to provide the driver of the modular vehicle 10 with the option to adjust the adjustable driver seat 52 according to their specific requirements. Thus, adjustment to different shapes, weights and lengths is available.

According to an embodiment, the driving area floor member 50 is substantially higher relative to the ground than the passenger area floor member 44. This configuration provides a good visibility to the driver, namely the environment in front of the front end 20, the environment close to the sides the modular vehicle 10, the passenger area 46 and the environment close to the rear end 18 of the modular vehicle 10.

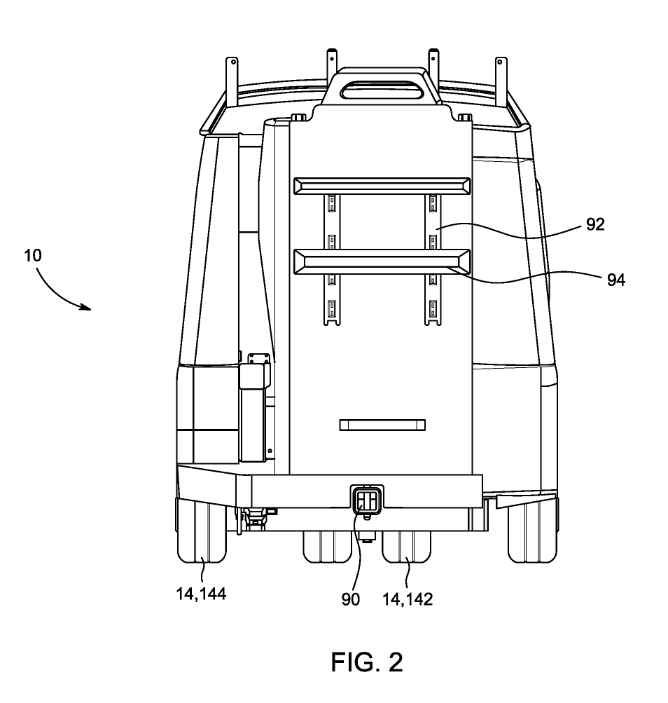

Now referring more specifically to FIG. 2, the modular vehicle 10 further comprises an attachment member 90 for attaching either a trailer cart or a luggage carrier. The attachment member 90 allows to releasably attach any additional self-standing wheeled component (such as the trailer cart) or an add-on wheeled component (such as the luggage carrier), and to detach any of them at any time. It further allows switching between use of either one of these pieces of equipment depending on circumstances. The attachment member 90 can further be used to attach releasably conventional objects such as, without limitation, a wheel chair, a dog cage supported by wheels, a two-wheel trailer for transporting equipment and/or sport garments and the like.

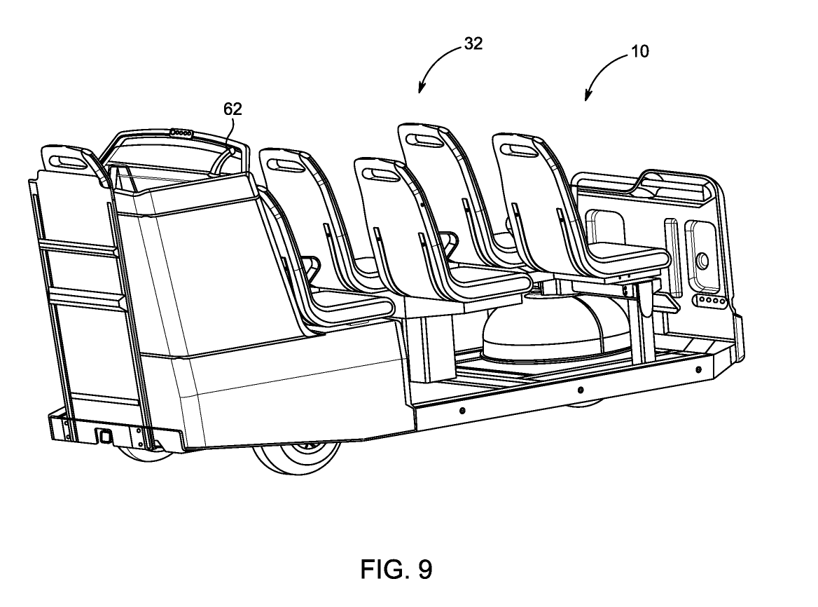

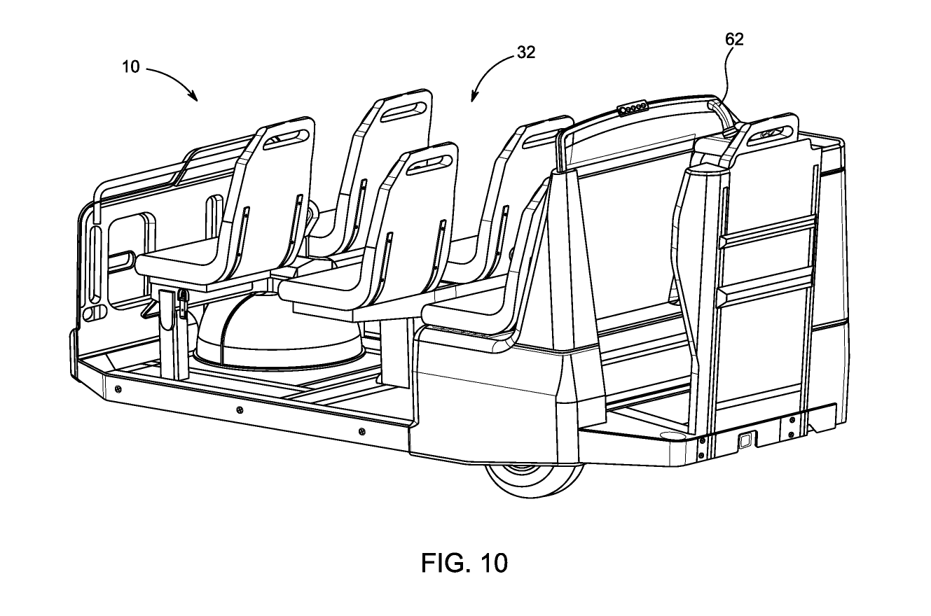

Referring additionally to FIGS. 7 to 12, according to an embodiment, the driving area 30 further comprises a driving console comprising a handheld controller 62 (e.g., a joystick) operatively connected to the drive components (see FIG. 13) for operating, namely controlling the speed and steering of the modular vehicle 10. The handheld controller 62 combines in a single component a plurality of switches, knobs, buttons, handles and/or levels allowing the driver to manage different aspects of the operation of the modular vehicle 10.

According to an embodiment, by changing the angle of the handheld controller 62 relatively to a vertical axial plane (a.k.a. tilting the handheld controller 62), the driver steers the modular vehicle 10. The steering of the modular vehicle 10 is performed by controlling the orientation of the front wheels 142, towards the left or the right based on the handheld controller 62 being tilted left or right relatively to the vertical axial plane. Furthermore, by changing the angle of the handheld controller 62 relatively to a vertical side plane, the driver controls the speed and direction of propelling of the modular vehicle 10 to move forward or backward, as well as to control the speed at which operates the modular vehicle 10. Thereby, by handling the handheld controller 62 simultaneously relatively to the vertical axial plane and vertical side plane, the driver is able to control movements of the modular vehicle 10 relative to a wide range of parameters.

According to an embodiment, the modular vehicle 10 comprises an electric motor 302 (see FIG. 13), one or more electrical batteries 306 (see FIG. 13) located under the back row 226 of seats 22 and driving components (see FIG. 13) involved in the steering and driving of the modular vehicle 10. With solely electric components, and particularly these electric components, the driver is able to operate the modular vehicle 10, including steering the modular vehicle 10, controlling the speed and direction of the modular vehicle 10, as slowing and braking the modular vehicle 10. All of these commands can be operated using solely the handheld controller 62.

According to an embodiment, the set of wheels 14 supporting the main frame 12 of the modular vehicle 10 are configured to allow the modular vehicle 10 to perform a 360-degree turn in almost no more than its own length. The relatively central location of the front wheels 142 close to each other relatively to the width of the main frame 12, the location of the rear wheels 144 spread over the width of the main frame 12, and the location of the electric batteries 306 relatively to the longitudinal axis 16 between the front wheels 142 and the rear wheels 144 with their weight of the batteries spread over the width of the modular vehicle 10 allows the modular vehicle 10 to be able to perform aggressive turns without affecting the stability of the modular vehicle 10 or the comfort of the passengers.

According to an embodiment, electric brakes (not shown) are mounted to at least one of the sets of wheels 142, 144. The electric brakes are for stopping the modular vehicle 10 upon command from the driver. According to an embodiment, a specific brake command (e.g. a button) electrically connected to the electric brakes is mounted on the handheld controller 62. According to an embodiment, the electric brakes are further commanded through forward and rearward tilting of the handheld controller 62. For example, tilting the handheld controller 62 in a rearward direction relatively to the vertical side plane when moving forward results in a command signal being transmitted to the electric brakes to operate.

According to an embodiment, a battery recharge system (not show) electrically connects the electric brakes to the batteries 306. The electric brakes transform kinetic energy retrieved from the modular vehicle 10 by the electric brakes into electric current, which is relayed by the battery recharge module and used to recharge the batteries 306.

According to an embodiment, a security system (not shown) checks the state of the modular vehicle 10 before any use of the modular vehicle 10 and is adapted to lock the electric brakes in a locked position if any electric defect is detected on the modular vehicle 10.

According to an embodiment, the handheld controller 62 comprises additional commands, embodied for instance as a locking switch (key switch 316, FIG. 13), for locking/unlocking the modular vehicle 10 and thereby preventing anyone who may operate the handheld controller 62 when the locking switch is in the locked position to operate the modular vehicle 10. According to an embodiment, controls comprise in a light switch (not shown) use to turn on or off headlights 66 (FIGS. 7 and 8) and the taillights (not shown). According to an embodiment, controls comprise a horn button (not shown) which is embodiments is part of the media system 320 (FIG. 13) that is electrically connected to a car horn (not shown). Accordingly, the car horn is activated upon the driver pressing the horn button. According to an embodiment, one or more of the above controls not involved in steering or driving the modular vehicle 10 are located on a dashboard (not shown) located in front of the driver, on the wall located between the passenger area 46 and the driving area 30, or aside the handheld controller 62.

According to an embodiment, the modular vehicle 10 further comprises a light system 322 (FIG. 13). The light system 322 controls the headlights 66 (see FIGS. 7 and 8) and taillights (not shown) (that may be embodied as dot-style front and rear lights). The light system 322 further controls brake light indicators (not shown) and turn light indicators (not shown) according to a standard color scheme. The light system 322, according to an embodiment, comprises a light pole (not shown) that is releasably mounted on the main frame 12.

According to an embodiment, the modular vehicle 10 further comprises a safe and audible reverse motion alarm (part of the media system 320, FIG. 13). A flashing high-level warning light (not shown) is also provided on the modular vehicle 10 according to an embodiment for informing individuals circulating in the pedestrian environment of potential hazards.

According to an embodiment, the modular vehicle 10 further comprises a microphone connected to one or more speaker(s) (both part of the media system 320, FIG. 13) so that the driver can directly communicate with the passengers of the modular vehicle 10 or with pedestrians around the modular vehicle 10. Alternatively, the driver can communicate with the passengers of the modular vehicle 10 or with pedestrians around the modular vehicle 10 using pre-recorded safety messages (i.e., using an audio button (not shown) available within the driving area 30 associated with a message unit (not shown, part of the media system 320, see FIG. 13).

According to an embodiment, the speed of the modular vehicle 10 is controlled (i.e., limited) to restrict the operation of the modular vehicle 10 between a maximum forward operating speed and a maximum backward operating speed to better suit the operator's requirements, safety parameters and passengers comfort. According to an embodiment, limitations to the forward and backward speeds are electrically implemented.

Back to FIGS. 1-6, the modular vehicle 10 comprises a set of electric batteries 306 (FIG. 13) powering the modular vehicle 10 that are located in a battery compartment located under the back row 226 and extending substantially throughout the full width of the modular vehicle 10. The configuration of the electric batteries 306 in a substantially evenly-distributed weight relative to the width of the modular vehicle 10 offers an optimal stability to the modular vehicle 10. Maintenance of the electric batteries 306 and of the electric motor 302 can be performed by simply swinging over the seats 22 part of the back row 226 in a forward manner relatively to a hinge assembly (not shown) so as to provide free access to the battery compartment (not shown) from their top; the poles of the electrical batteries 306 being located on their top for easy maintenance.

According to an embodiment, the modular vehicle 10 comprises hinged side panels (not shown) providing access to the battery compartment (under the back row 226) where the electric batteries 306 are located. According to an embodiment, the side panels are lockable. For maintenance and recharge of the electric batteries 306, one would unlock one of the hinged side panels, switch over the unlocked hinged side panel to free access the charging plug of a charger 308 (FIG. 13) and electrically connect the electric batteries 306 to a power source (the grid) to recharge the electrical batteries 306.

According to an embodiment, the driving area 30 further comprises a monitoring system (part of media system 320, FIG. 13) (i.e., a closed-circuit television monitor or closed-circuit television (CCTV) monitor and cameras) for allowing the driver to view hazardous areas around the modular vehicle 10 through a monitor and thereby be aware of the presence of kids, pedestrians, animals, luggage, other objects and the like that may be in the hazardous areas around the modular vehicle 10 (i.e., in front of the modular vehicle 10, behind the modular vehicle 10, and aside the modular vehicle 10 with risks of collisions). The monitoring system, according to an embodiment, also comprises a camera (not shown) for filming the passengers in the modular vehicle 10 during the trip and digital storage means (for example a hard drive or a Solid State Drive (SSD)) for storing the images recorded for administration purposes.

Now referring to FIG. 13, a schematic illustrates the electric component and connections of an embodiment of the modular vehicle 10. It must be noted that the schematic of the electric components and connections is voluntarily simplified to illustrate relationship between the components. Accordingly, connections comprising fuse boxes and fuses, dual connections to relay signals between components, and other components intended for transforming or stabilizing the current to be exchanged between components have been sometimes omitted and sometimes illustrated through a single line to highlight the components and the relationship between these components.

Back to the schematic of FIG. 13, the modular vehicle 10 comprises an electric motor 302, an alternative current motor or AC motor, electrically powered by a set of electric batteries 306 (such as a set of four (4) twelve (12) volts lead acid batteries or Absorbent Glass Mat (AGM) batteries) and controlled by a controller 304. The controller 304 is preferably a PLC (Programmable Logic Controller). The controller 304, according to embodiments, comprises a single PLC or is distributed over a plurality of PLCs. Of course, other types of controllers may be used, such as a connecting switch board for interconnecting relays. The controller 304 comprises input components for receiving signals from connected command components (e.g. handheld controller 310) and output components for transmitting command signals such as the signals responsible for the behavior of the electric motor 302.

Connected to the batteries 306 is a charger 308 for electrically connecting the batteries 306 to a power source (the grid) and thereby recharging the batteries 306.

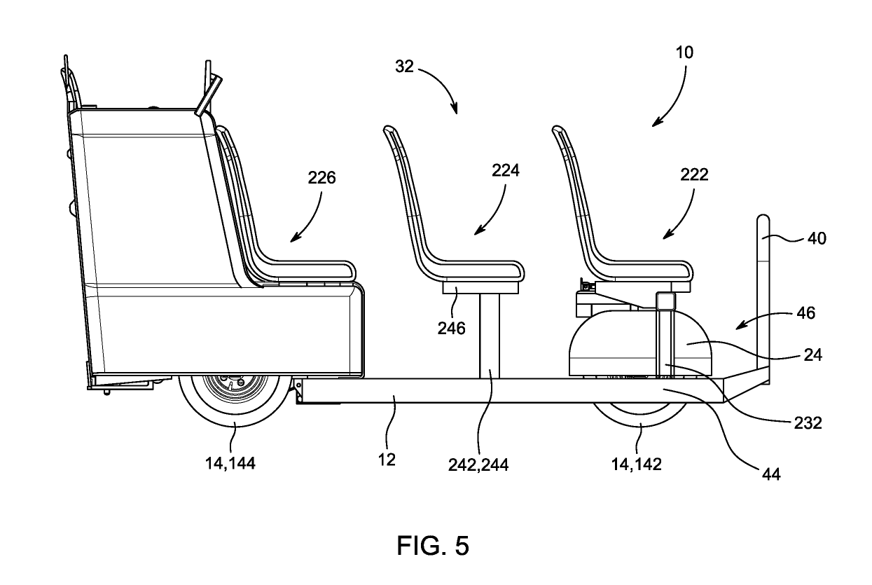

To steer and to operate the modular vehicle 10, a handheld controller 310 (illustrated on FIGS. 5 to 12 as a handheld controller 62) that, according to driver manipulations (tilting of the handheld controller 62 according to the vertical plans as discussed before), generates and transmits electric signals to the controller interface 312, which relays the signals to a steering servo 314. The steering servo 314 transmits signals to the controller 304, which interprets the signal in light of the controller programming; the controller being responsible for the operation of the electric motor 302. According to an embodiment, the controller interface 312, the steering servo 314 and the controller 304 are all responsible to process received signal in light of embedded programming, and to generate signals to be transmitted accordingly. One or more of the controller 304, the steering servo 314, the controller interface 312 and the handheld controller 310 may further generate, receive and/or process feedback signals for finer operation of the modular vehicle 10 by the driver.

According to an embodiment, the modular vehicle 10 further comprises a key switch 316, connected to the controller 304. The key switch 316 allows to lock/unlock the modular vehicle 10, preventing operation of the modular vehicle 10 when the key switch is in a locked position. According to an embodiment, the key switch 316 is operated using a physical key for power to be relayed to components of the modular vehicle 10. According to another component, the key switch 316 turns on/off a relay powering some operating components while another relay operating independently from the key switch 316 powers some non-operating components (e.g., lights).

According to an embodiment, the modular vehicle 10 also comprises driver seat controls 318, comprising commands and motors, for adjusting the driver seat.

According to an embodiment, the modular vehicle 10 comprises a media system 320. According to embodiments, the media system 320 comprises a sound system that comprise at least one of a horn, speaker(s), a microphone, alarm speaker(s), and other components. Some components (such as the horn) are connected directly to the handheld controller 310. Some of the components of the sound system are partially or fully automated, having their own controller and/or exchanging signals with the controller 304. Example of such a partially automated system is an alarm triggered when receiving a signal from the controller 304; the generation of a signal potentially depending on a signal received by the controller 304 from a detector (e.g. a close field detector, not shown). According to an embodiment, the media system 320 comprises a camera (e.g., closed-circuit TV or CCTV) recording images captures inside the modular vehicle 10 and/or in the environment of the modular vehicle 10.

According to an embodiment, the modular vehicle 10 comprises a light system 322. The light system 322 comprises, according to embodiments, manual lights and/or operational lights. Operational lights comprise stop lights, back-driving lights, direction lights, “on-operation” lights, etc. operating automatically or semi-automatically with respect to the operation of the modular vehicle 10. Manual lights comprise for example head lights and tail lights requiring the driver to turn them on.

The modular vehicle 10, according to an embodiment, comprises a monitor 324. The monitor 324, according to embodiments, display driving and operational information (e.g. battery charge level, speed, distance driven, operation time since last charge, etc.) and/or information related to other components (e.g. the camera). According to an embodiment, the monitor 324 comprises touch screen controls for the driver to input commands therethrough.

According to embodiments, the modular vehicle 10 is subject to many configurations. Each of these configurations embodies one or more of the features described above in relation with the different embodiments. Selection of one or more of the characteristics of a modular vehicle 10 of an embodiment are potentially determined by the environment in which the modular vehicle 10 is intended to operate. Accordingly, the environment may lead and/or dictate the inclusion and/or exclusion of one or more of the described features.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A vehicle for transporting passengers, the vehicle comprising:
a main frame comprising a rear end and a front end opposite the rear end, the main frame defining a longitudinal axis;
a passenger area comprising more than one row of at least two seats mounted side-by-side, the more than one row being substantially perpendicular to the longitudinal axis whereby the at least two seats in each of the more than one row face the front end, each of the at least two seats adapted for seating a single passenger; and
a driving area behind the passenger area at the rear end of the main frame.

2. The vehicle of claim 1, wherein each of the at least two seats comprises:
a seat surface; and
a backrest facing substantially toward the front end.

3. The vehicle of claim 1, wherein the driving area further comprises a driving console comprising a handheld controller operable by to operate the vehicle, wherein the handheld controller is operable by a driver in a standing or semi-standing position.

4. The vehicle of claim 3, wherein the handheld controller is able to be tilted about a first plane and a second plane, wherein tilting the handheld controller about the first plane controls forward and backward displacement of the vehicle and tilting the handheld controller about the second plane controls direction of the vehicle.

5. The vehicle of claim 4, wherein the handheld controller further controls at least one of speed of the vehicle and braking of the vehicle.

6. The vehicle of claim 3, wherein the driving area comprise a side wall, wherein the driving console is mounted to the side wall thereby enabling one-hand operation of the handheld controller, and hence the vehicle, by the driver.

7. The vehicle of claim 1, wherein the driving area comprises a side wall, a front wall and a back wall thereby closing off the driving area on three sides.

8. The vehicle of claim 1, wherein the passenger area comprises a passenger area floor and the driving area comprises a driving area floor, wherein the driving area floor is higher than the passenger area floor.

9. The vehicle of claim 1, further comprising two axles which are mounted to the main frame, wherein one of the two axles is for steering the vehicle, and wherein the driving area is located rearward of the two axles.

10. The vehicle of claim 1, further comprising a left side and right side, wherein the left side and the right side are at least partially opened allowing individuals to board on the vehicle and to leave the vehicle from the left side and the right side of the vehicle.

11. A vehicle for transporting passengers, the vehicle comprising:
a main frame comprising a front end and a rear end opposite to the front end, the main frame defining a longitudinal axis;
a passenger area comprising a row substantially perpendicular to the longitudinal axis, the row having at least two seats mounted side-by-side with each seat being for seating a single passenger and wherein the at least two seats face the front end; and
a driving area located behind the passenger area.

12. The vehicle of claim 11, wherein the passenger area further comprises another row also comprising at least two seats which face the front end.

13. The vehicle of claim 11, wherein each of the at least two seats comprises:
a seat surface; and
a backrest facing substantially toward the front end.

14. The vehicle of claim 11, wherein the driving area further comprises a driving console comprising a handheld controller operable by a driver to operate the vehicle, wherein the handheld controller is operable by the driver in a standing or semi-standing position.

15. The vehicle of claim 14, wherein the handheld controller is able to be tilted about a first plane and a second plane, wherein tilting the handheld controller about the first plane controls forward and backward displacement of the vehicle and tilting the handheld controller about the second plane controls direction of the vehicle.

16. The vehicle of claim 15, wherein the handheld controller further controls at least one of speed of the vehicle and braking of the vehicle.

17. The vehicle of claim 14, wherein the driving area comprise a side wall, wherein the driving console is mounted to the side wall thereby enabling one-hand operation of the handheld controller, and hence the vehicle, by the driver.

18. The vehicle of claim 11, wherein the passenger area comprises a passenger area floor and the driving area comprises a driving area floor, wherein the driving area floor is higher than the passenger area floor.

19. The vehicle of claim 11, further comprising two axles which are mounted to the main frame, wherein one of the two axles is for steering the vehicle, and wherein the driving area is located rearward of the two axles.

20. The vehicle of claim 11, further comprising a left side and right side, wherein the left side and the right side are at least partially opened allowing individuals to board on the vehicle and to leave the vehicle from the left side and the right side of the vehicle.
